(19) United States
(12) Patent Application Publication
(10) Pub. No.: US 2023/0344808 A1
(43) Pub. Date: Oct. 26, 2023

(54) SECURE NETWORK ROUTING AS A SERVICE

(71) Applicant: Invisv Inc., Marina Del Rey, CA (US)

(72) Inventors: Paul Schmitt, Santa Monica, CA (US); Barath Raghavan, Irvine, CA (US)

(21) Appl. No.: 18/306,112

(22) Filed: Apr. 24, 2023

Related U.S. Application Data
(60) Provisional application No. 63/334,446, filed on Apr. 25, 2022.

(51) Int. Cl. H04L 9/40

(52) U.S. Cl. CPC H04L 63/0428; H04L 63/20; H04L 63/0421

(57) ABSTRACT

Systems and methods for providing secure network routing as a service. In some aspects, the system generates or retrieves a database including information related to connections existing in one or more networks and devices included in the one or more networks. The system receives, from a data source device, a request for a data path including one or more data processing tasks to be performed by devices in the one or more networks on behalf of the data source device. The system, in response to receiving the request from the data source device, processes the request to generate a data path including connection and device information from the one or more networks in the database. The system transmits the data path to the data source device for routing network packets to a data destination device.

### CROSS-REFERENCE TO RELATED APPLICATIONS

This application claims the benefit of priority of U.S. Provisional Patent Application No. 63/334,446, filed on Apr. 25, 2022, which is hereby incorporated by reference in the present application.

### BACKGROUND

Prior techniques in network routing include network-directed routing of network packets (also known as default routing) and source-directed routing of network packets (also known as source routing). The specification of the Internet Protocol (IP) included the ability for source hosts to specify a series of IP-address next hops through which each packet should be routed. This functionality was not used in most networks or by most network operators because network operators seek to control the paths that network traffic takes, and source-controlled routing conflicted with this goal. Subsequent work described how to authenticate packets that were being source routed through networks, enabling the intermediate network hops to verify that the packets were authorized to be sent through those next hops.

### SUMMARY

In some aspects, systems and methods are described for providing secure network routing as a service. The system generates, using a network mapping process, a database including information related to connections existing in one or more networks and devices included in the one or more networks.

In some embodiments, the system receives, from a data source device, a request for a data path including one or more data processing tasks to be performed by devices in the one or more networks on behalf of the data source device.

In some embodiments, the system, in response to receiving the request from the data source device, processes, using a routing process, the request to generate a data path including connection and device information from the one or more networks. The connection and device information may be obtained from querying the database.

In some embodiments, the data path is configured for the one or more data processing tasks to be performed by devices in the one or more networks on behalf of the data source device.

In some embodiments, the system transmits the data path to the data source device for routing network packets to a data destination device.

In some embodiments, the data source device, in response to receiving the data path, determines whether the data path satisfies the one or more data processing tasks included in the request.

In some embodiments, the data source device, in response to determining that the data path satisfies the one or more data processing tasks, selects the data path for routing the network packets to the data destination device.

In some embodiments, the one or more data processing tasks to be performed by devices in the one or more networks on behalf of the data source device include removing metadata from network packets to be transmitted, shuffling the network packets, or re-encrypting the network packets.

In some embodiments, the devices in the one or more networks are determined to meet requirements as to a country, a network, a physical boundary, or a logical boundary within which or outside of which the network packets, communication, code, or computation is performed or conveyed.

Various other aspects, features, and advantages of the disclosure will be apparent through the detailed description and the drawings attached hereto. It is also to be understood that both the foregoing general description and the following detailed description are examples, and not restrictive of the scope of the disclosure.

### BRIEF DESCRIPTION OF THE DRAWINGS

FIG. 1 is a block diagram showing the network as it exists today, in which sources communicate with destinations over the Internet through the default intermediary network(s) and contrast this with an alternative enabled by this invention in which such communication can occur through secure channels through alternative intermediary networks.

FIG. 2 is a block diagram showing an example environment in which the secure network routing as a service system could be used, with an external orchestrator coordinating with intermediary networks that have network hops at which Processing Executors (PEs) can perform desired processing on the desired path from the source to the destination.

FIG. 3 is a block diagram illustrating components which, in some implementations, can be used in a system employing the disclosed technology. FIG. 3 shows how a Global Decentralized Service Plane can enable the provision and discovery of possible secure routes and executors through the network, enable a marketplace for services, enable the selection and purchase of such services, enable a source host to use paths that it selected, and enable intermediate hops in intermediate networks to provide the desired service in a manner that manages load, implements the end-to-end desired functionality, authenticates traffic, mitigates abuse of the network, performs execution in a secure enclave as needed, and chains together many such next hops and networks to achieve the desired functionality of the source and/or destination.

FIG. 4A is a flowchart showing an example operation of the system of FIG. 3 for “initializing” the present system.

FIG. 4B is a flowchart showing an example operation of the system of FIG. 3 for providing a path from a Source to a Destination.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or more instantiations or embodiments in the present disclosure can be, but not necessarily are, references to the same instantiation or embodiment; and, such references mean at least one of the instantiations or embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The inventors recognized that expressing source routes concisely and in a manner that did not reveal the internal network topology of a network operator has been possible. In addition, the inventors recognized researchers showed how large network operators could use software-based packet processing techniques and how these network operators could make agreements to direct traffic between one another through alternative routes through the Internet. But, the inventors also recognized problems of prior systems, and the need for a system that permitted secure routing of multiple packets though multiple networks, which could be offered as a service.

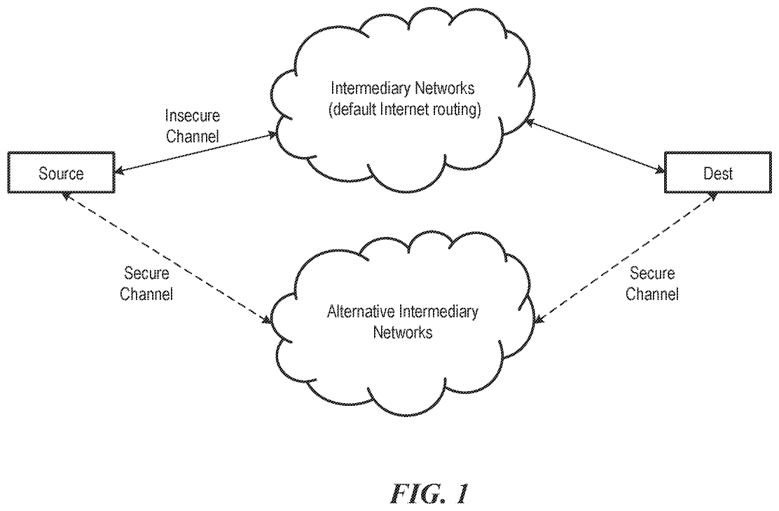

Several implementations of the described technology are discussed below in more detail in reference to the figures. Turning now to the figures, FIG. 1 is a block diagram illustrating an overview of network devices on which some implementations of the disclosed technology may operate. The devices can comprise hardware or components of a device that send, receive, or modify data over a computer network. These devices can be the originators of the network data, devices that perform processing of network data, and/or devices that are the recipients of network data. In many networks, devices that wish to communicate have available a default route through intermediary network devices that reside in intermediary networks that enable communication from a source device to a destination device. In the disclosed technology, devices can use a secure channel such as Transport Layer Security (TLS) to communicate through one or more alternative intermediary networks that similarly enable communication from a source device to a destination device, doing so in a manner that achieves one or more desired properties or objectives. A network path may comprise one or more intermediary devices and/or intermediary networks, conveying, partially or fully, network data from a source device to a destination device.

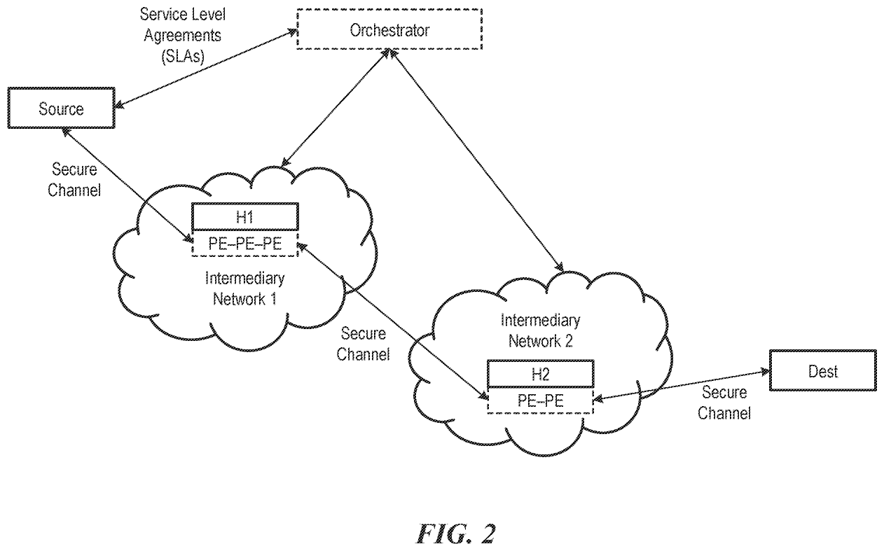

FIG. 2 is a block diagram illustrating an overview of devices on which some implementations of the disclosed technology can operate. The shown devices can express desired properties or objectives of the communication service that they receive from the intermediary devices that reside in the alternative intermediary networks. These desired properties can be thought of as a Service Level Agreement (SLA) which can be an agreement between the source device and one or more of the other devices through which communication occurs. A source host determines certain processing tasks to be accomplished by one or more devices in the one or more networks for data packets to be transmitted to a destination host. For example, the source host can be a user computer that is to send a document or file to a destination computer, where a user associated with the user computer desires end to end encryption or other tasks to be performed on data packets associated with the document or file. The orchestrator is an entity separate from entities operating the intermediary networks (and devices in those intermediary networks). For example, the orchestrator may be a separate corporation or other business entity wholly separate from corporations or other business entities owning, operating, or managing the intermediary networks.

In some implementations, there can be one or more sources communicating via the systems described in this invention with one or more destinations. The invention thus supports one-to-one communication, one-to-many communication, many-to-one communication, and many-to-many communication.

In some implementations, a true source that originates network traffic and/or a true destination that sinks network traffic may not be involved in requesting and/or accessing the services enabled by this system and instead one or more intermediary nodes employ these network services invisibly, along their default path through the network, from such a true source and/or to such a true destination.

The devices that enable communication between a source device and a destination device, such as a device labeled H1 in FIG. 2, can implement one or more Processing Executors (PEs) capable of implementing one or more desired data processing tasks on behalf of the source and/or destination devices. Such PEs can implement some or all of the functionality desired by the source and/or destination devices and some or all of the functionality described in the SLA that was expressed by either the source and/or destination devices and/or the orchestrator or intermediary network(s). PEs can express their capabilities in the form of PE specifications (PES) that use a standard format such as JSON to list available resources at the PE (such as bandwidth, CPUs, storage, and other standard capabilities, and network-relevant information such as its geographic location/Point-of-Presence (PoP)). These form one half of an SLA, describing what a PE is capable of performing.

In some implementations, PEs can be implemented on edge cloud processing infrastructure. Alternatively or additionally, PEs can be implemented using Network Function Virtualization infrastructure and/or serverless execution environments.

These PES descriptions can be communicated to/from an orchestrator device or devices that can provide information about one or more intermediary devices that can be used for secure network communication. The orchestrator can make the full list of PES descriptions available via a website or online database for any source to examine. A source can either itself search the PES descriptions or send the orchestrator a list of desired properties, once again specifying network properties such as the delay/latency and/or jitter of a network device and/or a network path that uses a device, the network bandwidth or capacity of a device and/or a network path that uses a device, the security and/or privacy properties of a device and/or a network path that uses a device, the processing capabilities of a device and/or a network path that uses a device, the cost of a device and/or a network path that uses a device, the physical or logical location of a device and/or a network path that uses a device, the device manufacturer and/or type, the available peering and/or transit network names or autonomous system number, and/or the reliability of a device and/or a network path that uses a device, as well as other parameters. With both the available services (in the form of PES descriptions) and the desired properties from the source, the orchestrator can create a Service Level Agreement (SLA) as a new document, once again in JSON or some other format, that specifies the properties (e.g., bandwidth, latency, security, processing, etc.) achieved by the one or more intermediary networks (and their hosts) to achieve the properties desired by the source. In one instantiation, the source can explicitly choose the path (and thus the nodes with which it is engaging in an SLA) by listing the PES descriptions it would like to employ in sequence and the minimum properties it requires of each, once again in a JSON document or other specification format. Alternatively, in another instantiation, the source can specify its minimum requirements for a path, and these are sent to the orchestrator, which performs a matching operation to find the minimum cost path of intermediate networks and intermediate hosts through which a path can be formed that meets the desired properties of the source. The cost can be defined in monetary terms, compute or network resources, or other metrics. The cost metric can optionally be specified by the source to the orchestrator when it describes the desired properties.

In some instantiations, the source and/or destination can use multiple paths, and each mention of a single path in this document should be considered to apply to multiple simultaneous or sequential paths.

In another instantiation, the source also specifies a second complementary specification in a JSON document, or other format, the path from the destination back to the source. This can alternatively be under the control of the destination, which performs the same type of operations as the source as from its perspective it is a source for the reply traffic back to the original source.

In another instantiation, these PES descriptions, source request descriptions, and SLAs could be expressed in an XML-based format based on that of the GENI testbed tool Gush based upon the SWORD system. (GENI is an open infrastructure for at-scale networking and distributed systems.)

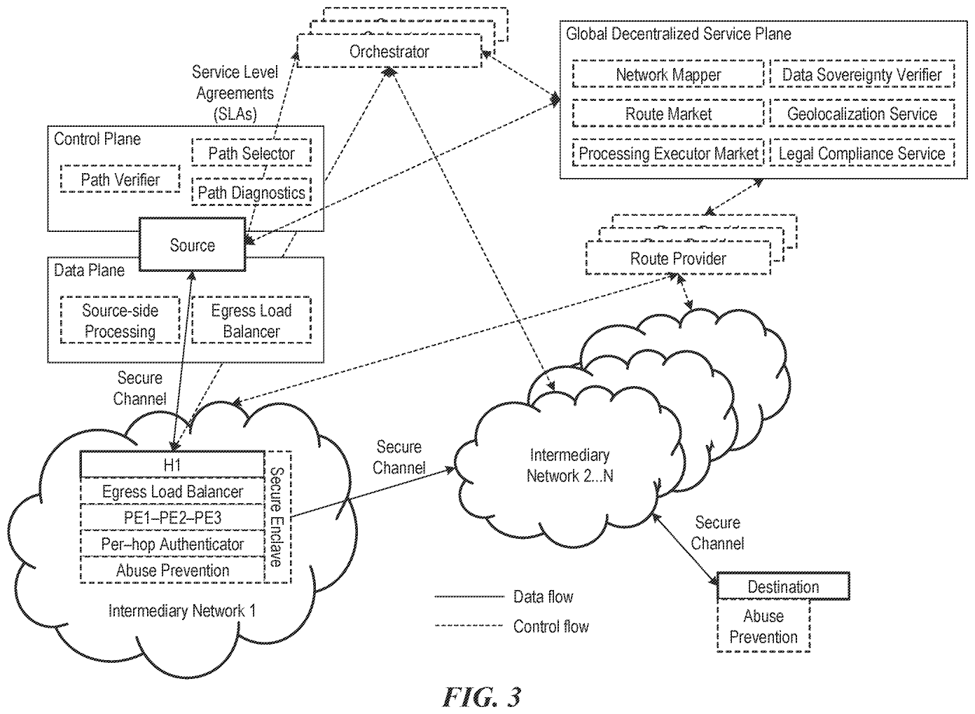

FIG. 3 is a block diagram illustrating an overview of devices on which some implementations of the disclosed technology may operate. In this illustration are devices which may reside in one or more locations operated by one or more organizations or entities; these devices can comprise a distributed service plane that can manage secure network routing services for one or more devices globally. In addition, the source devices, intermediary devices, and/or destination devices can consist of one or more components responsible for on-device functionality such as extensions to the software-based network stack, hardware accelerators for enabling faster packet processing and/or offloading software processing to hardware, and/or other hardware components to perform secure/trusted execution such as a standard or non-standard Trusted Execution Environment (TEE).

The Global Decentralized Service Plane depicted in FIG. 3 can consist of a network mapper, route market, processing executor market, data sovereignty verifier, geolocation service, and/or legal compliance service. Each of these components can run on one or more network servers, and each is discussed separately below. In some instantiations, the orchestrator(s) can be separate services. In some instantiations, the orchestrator(s) can be part of the global decentralized service plane.

In some instantiations, the Global Decentralized Service Plane can be implemented using a network of nodes executing a blockchain-based consensus protocol. In some instantiations, the Global Decentralized Service Plane, and/or other elements of this system including the buying and selling of network service, route access, PE execution time and/or access, and any other computational or network resources, can be mediated by, paid for, and/or coordinated using a blockchain-based currency.

The network mapper can survey, aggregate, or otherwise compile together information about the connections that may exist in one or more networks and the qualities and properties of those connections and the devices that make up those networks. Some of the properties to be mapped are inherent to the underlying networks available on the Internet, independent of the services being offered by intermediary networks. Some of the properties to be mapped are inherent to the intermediary networks and their nodes and services, and to map these the network mapper can use the services being offered by those intermediary networks, as if the network mapper is a source and/or destination, to map the specific qualities and properties of the intermediary networks and nodes.

The Network Mapper can perform end-to-end measurements via the Internet and/or available intermediary networks using existing standard network measurement tools such as ping, traceroute, iperf, and standard techniques for bandwidth estimation such as packet pair. In some instantiations, the network mapper may include novel measurement mechanisms. In these end-to-end measurements, the network mapper can employ temporary source and destination nodes that are located in many different networks globally, both in possible intermediary networks and in other networks in the Internet. These measurements can consist of performance characteristics of a path and/or the intermediary networks and/or PEs on the path, the processing characteristics of such networks, the network topology (connectivity between networks and nodes), and so on. The network mapper can also incorporate pre-existing public data sets of Internet topology such as CAIDA's Macroscopic Topology Measurements and University of Oregon's RouteViews. With this information consolidated, the network mapper can make available to sources and/or destinations knowledge about what network paths may be more or less desirable to meet certain target SLAs. In some instantiations, intermediary networks may use this information to choose to launch new nodes/services in possibly-desirable locations and/or with possibly-desirable functionalities. The information from the network mapper can also be used by route providers who wish to combine services from one or more intermediary networks into a path through the network that may be desirable to some sources and/or destinations.

The route market can consist of a market mechanism to match or otherwise engage buyers and sellers who are interested in routes through the networks and/or the devices in those networks. The route market can be populated with route information that is generated and/or aggregated by route providers which can be independent devices that combine information about available intermediary devices and the network and processing properties that they can provide.

The route market can consist of real-time information that specifies available routes and services from PEs in intermediary networks, encoded in a format such as JSON or XML using an extension to standard encodings for both networking and processing resources as discussed herein with respect to PES descriptions. The route providers can themselves be independent of intermediary networks and/or be operated by intermediary networks, but are logically distinct from the networks themselves and/or the nodes within those networks. Route providers specify what they believe to be useful services that can be used by sources and/or destinations, along with specifications of the performance, security, and reliability properties those routes would deliver and the costs for those services.

For example, a route provider could describe a two-hop route that begins with a first hop in an intermediary network in a network Point-of-Presence or data center in Los Angeles which provides a PE running a Linux-based Network Address Translation run within an Intel SGX-based Trusted Execution Environment (TEE) followed by a route from that first hop, via a 10 Gbps encrypted connection using TLS with 99.99% uptime and 0.0001% packet loss, to a second hop at another intermediary network Point-of-Presence or data center in Northern Virginia which provides a PE running a HTTP/3 CONNECT web proxy secured by TLS which then sends outbound requests on the source's behalf to destinations with guaranteed 10 Gbps bandwidth and 99.999% uptime and 0.0001% packet loss.

A route provider that specifies useful services and/or routes through intermediary networks and their PEs can be responsible for receiving funds from sources that use the service and disbursing those to intermediary networks with which the route provider has made agreements. The route provider can also assume the risk and/or responsibility for the network packets and/or usage of the routes it provides in case of complaints by third parties; intermediary networks can pass along complaints to the route provider who can then be responsible for taking action by withdrawing a route, terminating an agreement with one or more sources and/or destinations, etc.

Routes provided by route providers can be in agreement with sources alone, destinations alone, or both sources and destinations. Some routes can be intended for use by a known source, who enters into agreement with a route provider, to communicate with some unknown/arbitrary destination(s). Some routes can be intended for use by a known destination, who enters into agreement with a route provider, to receive traffic from some unknown/arbitrary source(s). Some routes can be intended to be used by a conjunction of known source(s) and destination(s).

Routes provided by route providers can be partial routes that do not provide connectivity from end to end, but instead may connect some sequence of intermediate network nodes and/or sources and/or destinations, and may or may not interconnect or transit PEs. A route provided by a route provider can be as short as a single node with zero or more PEs present at that node.

The processing executor (PE) market can consist of a market for code and other technologies for processing executors to be run on one or more devices in one or more networks. The PE market can resemble an “app store” for applications in mobile platforms. PE code developers can describe the functionality of their code, submit the code for automated or manual review to the PE market, and if approved make available for free or for sale/license their PE functionality for use by one or more nodes in one or more intermediary networks. The PE code can also be cryptographically signed for authenticity by the developers, by the market, and/or by other parties, which can enable verification of the authenticity of the PE code running at some intermediary network's node. In some instantiations this verification can be done with attestation functionality supported by existing hardware or software based Trusted Execution Environments (TEEs) such as Intel SGX, Amazon Nitro, ARM TrustZone, AMD PSP/SEV, etc. This can provide assurances to a source and/or destination node using PE functionality that the code that is promised to be running at a specific node along the path is indeed the code that is in fact running. The PE market can also supply APIs for PE code developers to use to ease the integration of new PE implementations and/or encourage code re-use.

The data sovereignty verifier can verify that one or more of the devices that can be used in a route meets requirements and/or agreements as to the country, network, or other physical or logical boundary within which or outside of which network data, communication, code, or other computation is performed or conveyed. The data sovereignty verifier can examine the properties of the routes produced by route providers and use information from the network mapper to determine whether the intermediary networks and/or the nodes in the intermediary networks and/or the paths between the intermediary networks involve transmission of data through national boundaries or otherwise through jurisdictions that are not desired by one or more parties to the communication. This data sovereignty requirement can be expressed in the source's and/or destination's specification in JSON or XML or another similar format and be verified by the verifier either before, during, or after some route is used. The verification result can be used simply as information to the parties involved or can be used to terminate use of the route, re-route through another route, change security parameters/settings for the communication in question, change processing at one or more PEs along the route, change the agreed upon price paid for service, and/or change the SLA for the route.

The geolocation service can verify some or all location information about devices in one or more networks and can do so while providing none, some, or a high degree of privacy. As the routes provided via the secure network routing as a service market can in some cases hide the true origin point of a source of network traffic, the parties involved can choose optionally to convey additional metadata along with network traffic so as to inform a destination regarding the geographic whereabouts of a source or sources of traffic. The use of and/or revelation of geolocation information can optionally be specified in SLAs in some instantiations.

The legal compliance service can provide functionality to allow inbound legal requests for termination of service, blocking of data transmission by one or more devices, intercepted communications for one or more devices, and/or meeting other legal requirements for one or more routes through the network used by one or more devices. For example, if a user of the service sends packets/data to a destination or destinations that object to their receipt of the packets/data, the packets/data can be stamped with a privacy-preserving but identifying stamp that enables the orchestrator to initiate an action to remediate the situation. For example, if a request to stop the transmission is made by a recipient, the orchestrator can, without de-anonymizing the traffic, tell a route provider, intermediary network, nodes, and/or other coordinating parties to take action to stop the transmission of that traffic flow to that destination.

The source device depicted in FIG. 3 can consist of a distinct control plane and data plane, wherein the control plane can manage how data is communicated and/or processed and the data plane can manage the communication and/or processing of data. In the control plane at a source device there can be a path verifier that verifies that a path that is to be used at present or in the future meets one or more of the properties desired by the device and/or that is listed in a corresponding SLA; this verification is in addition to any verification done by the service plane, routing providers, and/or others. The path verifier can take as input paths that the orchestrator believes meet the source's and/or destination's criteria. The path verifier can perform verification to independently verify that the route, when used as a path for data packets, indeed meets the criteria. For example, this verification can be done using standard tools such as ping, traceroute, iperf, and other mechanisms used by the network mapper.

The path selector can use information retrieved from the service plane, orchestrator, the path verifier, and/or other sources of information, and combine this information in some manner to select a path for data from this device to use. The path selector can weight the accuracy and trustworthiness of the information provided in various ways. For example, the path selector can deem measurements performed by the path verifier to be of the highest trustworthiness, and can opt to discard any routes during path selection that the path verifier determined does not meet the requisite criteria. Alternatively, the path selector can use information from the path verifier as a weighted measurement along with other information supplied by the service plane, so path selection decisions can be done based upon a combination of supplied information and source-collected information.

The path diagnostics component can use information from measurements taken previously or in real time to assess the quality and characteristics of the network path that is in use. For example, after a path is selected, the path diagnostics component can send a small amount of additional traffic along the path, once again potentially using standard network measurement tools, to ensure that the criteria and the SLA are continuing to be met during live use of the path. If the criteria and/or SLA are found by the path diagnostics component to not met by the path in real time, then it can signal to the source to terminate the use of the path and/or for the source to signal to the orchestrator that an SLA violation occurred. In some instantiations, if an SLA violation is found to have occurred, the orchestrator, source, and route provider can perform reconciliation to determine the nature and extent of the violation and perform manual or automated remedies including financial or non-financial remuneration, the selection of alternative routes for immediate or later use, etc.

The source device data plane can perform actions on the data that is transmitted or that is to be transmitted by the source device. These actions include processing by one or more source-side processing modules and egress load balancing. The data transmitted by the source device, optionally after processing, can be placed into a secure channel that can be secured by encryption, packet obfuscation, packet normalization, traffic padding, and other techniques to improve security and privacy. In some instantiations, the source and/or destination can use Processing Executor code either from the PE market or elsewhere in their data planes. This can enable them to perform operations similar to or the same as nodes in intermediary networks.

FIG. 3 illustrates that one or more intermediary networks can have one or more devices that perform operations on the data that they receive on behalf of the source and/or destination devices. Such intermediary devices can implement an ingress load balancing mechanism to distribute the data received from a previous device in such a way as to distribute the processing work or load across multiple devices and/or sub-device processing units such as CPU cores or individual devices in a rank of servers. In some instantiations, the load balancing mechanism can aid in improving the privacy of the source and/or destination by obscuring the data being transmitted and/or processed by the nodes as the work is divided by the load balancer across multiple processing units.

Intermediary devices can then perform a specified sequence of executions of PEs, such as performing firewalling followed by Network Address Translation followed by re-encryption for IPsec tunneling, that perform processing as desired by source and/or destination devices. As part of this processing the intermediary devices can perform authentication at that hop so as to verify the responsible party for the data that was received to be processed and/or any information related to billing the responsible party, the authenticity of the received data, etc. In some instantiations, each intermediate device has a database to store billing/charging data, which is then routed to the Global Decentralized Service Plane to ensure that each intermediary is appropriately paid for the role they played in providing routing and PE services and the amount of data and/or time and/or resource consumption they incurred. In addition the intermediary devices can perform operations to prevent abuse of the system, including exact or approximate logging of the data that is received in one or more data structures or databases. The code executed and/or the data processing performed at this intermediary device can be performed in a secure environment such as a secure hardware enclave and/or trusted execution environment wherein the hardware can attest that the desired code was executed and that the intermediary node cannot see the data being processed.

In some instantiations a PE can perform privacy and/or security enhancing processing at a node, such as removing metadata from traffic, shuffling and/or mixing the traffic, re-encrypting the traffic, and/or other similar privacy and/or security operations.

One or more intermediary devices in one or more intermediary networks can be chained in sequence by one or more source devices to communicate with one or more destination devices. Each intermediary device can use information provided in data packets themselves or provided out of band (via control plane communication) to determine the next hop and/or destination to send the data to.

In some instantiations, intermediary networks can select whether to offer services within their networks based upon the ingress and egress capacity into and out of their networks from/to neighboring networks and/or based upon the processing capacity available to the nodes within the network. Intermediary networks can perform ordinary load balancing on traffic, perform traffic engineering to ensure there remains capacity for both existing and new traffic, and/or can perform admission control to limit the traffic they accept into their networks and/or on specific routes, at specific nodes, or of specific service types.

Destination devices can perform abuse prevention operations to assess whether data they receive is undesirable and to notify the intermediary devices, intermediary networks, decentralized service plane, orchestrators, and/or source devices if some received data is unwanted or considered to be an attack or otherwise an abuse of the network. In this event, other devices in the overall architecture can take action to stop the flow of such unwanted data packets and/or block or remove the sources of that data as warranted. For example, a destination can extract an anonymous path identifier from the packet header which contains a cryptographic signature or MAC of the packet and can transmit this to the legal compliance service operated in the service plane to request that the source of those packets be prevented from sending further packets via the path in use. The legal compliance service can verify the request and the cryptographic information and perform blocking or other operations to address the source of network abuse.

In some implementations, a destination device can collect statistics about the quality of the data transmission (via some route through which it is receiving data) from its perspective, such as by monitoring the bandwidth, delay, loss, jitter and other network characteristics, and/or other expected processing from the PEs on the path. In some implementations, a destination device can report its statistics and feedback, including whether the route appeared to adhere to the expected SLA, to the orchestrator; in some implementations, the orchestrator can convey this feedback from destinations for the verification of paths and/or make this information available to others for use in their path selection decisions.

Some advantage of the disclosed technology can be that it enables communicating devices, such as one or more sources and one or more destinations, 1) to select paths or routes for their data to be communicated, 2) that these paths or routes can be chosen based upon desired properties as described in SLAs so as to achieve various security, privacy, performance, reliability, and/or other objectives, 3) the paths can be made available and implemented by independent, third-party devices in intermediary and independent networks in addition to those present on the default network route from a source to a destination, 4) the intermediary device(s) can perform desired processing in PEs that achieve properties desired by the source and/or destination devices, 5) that independent verification methods can be applied both by a decentralized service plane and orchestrators and by potential source and destination devices so as to ensure that intermediate devices are satisfying the properties that are promised in the SLAs, and 6) that independent and dynamic market and pricing mechanisms can enable appropriate pricing and the matching of supply and demand among those devices that is not possible in common networks such as the Internet today (in some instantiations, real-time data exchange by intermediary networks can lower pricing when network loads are lower, can offer levels of security at differing prices, encourage time of day routing to avoid peak demands, and provide service with different pricing in different network topological and/or geographical locales based upon such fluctuations).

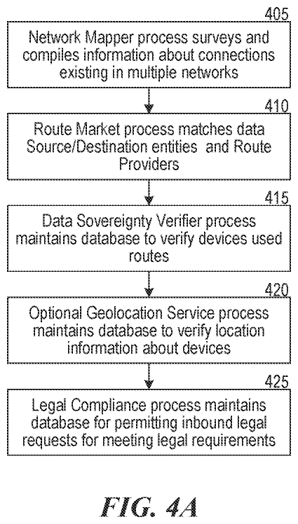

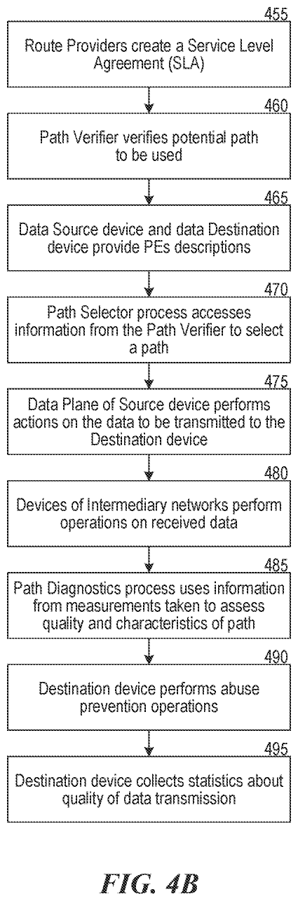

FIG. 4A shows an example operation 400 of the system of FIG. 3 for “initializing” the present system. In block 405 a Network Mapper process in a Global Decentralized Service Plane surveys and compiles in a database information about connections existing in multiple networks, about qualities and properties of those connections, and about devices that make up those networks.

In block 410, a Route Market process matches or otherwise engages data Source/Destination entities (buyers) and Route Providers that manage Intermediary networks (sellers) who are interested in routes through the networks and/or the devices in those networks. The Route Market process populates a database with route information from the Network Mapper and with information provided by Route Providers, which includes independent devices that provide to the Route Market process information about available intermediary devices and the network and processing properties that those devices can provide. The Route Market process then provides to a buyer or Source the route and device information, including services provided by Processing Executors (PEs) in intermediate networks, including performance, security, and reliability properties.

The Route Providers may or may not manage the intermediary networks. Instead, the Route Providers may be third parties who simply receive fragments of routes, nodes, or PEs as offered by intermediary networks and decide to create a new route that stitches some combination of those together into a slightly larger, complex, or more useful route.

In block 415, a Data Sovereignty Verifier process maintains a database which it uses to verify that devices used in one or more routes meet requirements and/or agreements as to the country, network, or other physical or logical boundary within which or outside of which network data, communication, code, or other computation is performed or conveyed. The Data Sovereignty Verifier examines properties of routes produced by Route Providers and uses information from the Network Mapper to determine whether intermediary networks and/or devices in the intermediary networks and/or paths between the intermediary networks involve transmission of data through national boundaries or otherwise through jurisdictions that are not desired by Source or Destination entities.

The Data Sovereignty Verifier can add its own stamp (e.g., a cryptographic signature) attesting to its verification of a route, node, network, PE, or other entity as meeting one or more requirements (such as what country/legal jurisdiction it represents).

In block 420, an optional Geolocation Service process maintains a database which it uses to verify some or all location information about devices in one or more intermediary networks and does so while providing privacy. Geolocation of network services is not required for the present service, so some routes may not have associated geolocation information.

In block 425, a Legal Compliance process maintains a database which it uses for permitting inbound legal requests for termination of service, blocking of data transmission by one or more devices, intercepted communications for one or more devices, and/or meeting other legal requirements for one or more routes through the network used by one or more devices. Thus, the Legal Compliance process monitors a route, and if a stored legal requirement affecting a device, location, etc. is related to the route, the Legal Compliance process executes a corresponding operation based on stored requirement.

FIG. 4B shows an example operation 450 of the system of FIG. 3 for providing a path from a Source to a Destination. Beginning at 455, the Route Providers, alone or with desired properties from an Originator, create a Service Level Agreement (SLA). Alternatively or additionally, an Orchestrator can create an SLA.

At 460, a Path Verifier process of a Control Plane verifies that a potential path to be used at present or in the future meets properties desired by the device and/or is listed in the SLA.

At 465, a data Source device and a data Destination device provide PEs descriptions and desired properties to the Orchestrator. The Source and Destination can provide SLAs, but the Route Providers need access to network properties (e.g., performance, jurisdiction, etc.) and may or may not care about what PEs are available (depending upon traffic they are sending.)

Note, the aspects of the present system need not involve both Source and Destination—sometimes the system can just employ a Source, or just a Destination, or even be hidden from a true Source or Destination (where a network provider provides certain functionality noted above).

At 470, a Path Selector process accesses information from the Path Verifier to select a path for data for the Source device to use.

At 475, a Data Plane of the Source device performs actions on the data that is to be, or is currently, transmitted to the Destination device. These actions include processing by source-side processing modules and egress load balancing. Other actions can include encryption, packet obfuscation, packet normalization, traffic padding, and other techniques to improve security and privacy. The data processing can additionally, or exclusively, be performed at one or more PEs along the selected path.

At 480, devices of Intermediary networks perform operations on the received data, such as ingress load balancing to distribute the data received from a previous device in such a way as to distribute the processing work or load across multiple devices and/or sub-device processing units such as CPU cores, which can further improve security. Further, the devices of Intermediary networks perform specified executions of PEs as desired by the Source device. The devices of the Intermediary networks authenticate, for their hop in the route, to verify the Source/responsible party for the received data to be processed and/or any information related to billing, the authenticity of the received data, etc.

At 485, a Path Diagnostics process of the Source device uses information from measurements taken previously or in real time to assess quality and characteristics of the network path that is in use. Alternatively or additionally, the Path Diagnostics can reside elsewhere in the system, not just at the Source. The system can employ an independent path diagnostic service that provides data about path quality to sources and/or destinations.

At 490, the Destination device performs abuse prevention operations to assess whether the received data is undesirable, and if so, notifies the Intermediary networks, Decentralized Service Plane, the Orchestrator, and/or the Source device if the received data is unwanted, considered to be an attack, or otherwise an abuse of the networks. The Destination can access resources for the Global Decentralized Service Plane, such as the Data Sovereignty Verifier. The Destination can also employ the abuse prevention mechanisms noted herein.

At 495, the Destination device can collect statistics from its perspective about the quality of the data transmission (via the route through which it is receiving data), such as by monitoring the bandwidth, delay, loss, jitter, and other network characteristics, and/or other expected processing from the PEs on the path. The Destination device can report its statistics and feedback, including whether the route appeared to adhere to the expected SLA, to the Orchestrator.

A database at each Intermediate device stores billing/charging data, which is then routed to the Global Decentralized Service Plane to ensure that each Intermediary party is appropriately paid for the role their device played in providing routing and PE services and the amount of data and/or time and/or resource consumption incurred. As noted above, one way payments or contracts in the present system can use a blockchain or cryptocurrency.

The disclosed technology can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A system for providing secure network routing as a service, comprising:
one or more processors; and
a non-transitory computer-readable medium storing instructions that, when executed by the one or more processors, cause operations comprising:
generating, using a network mapping process, a database including information related to connections existing in one or more networks and devices included in the one or more networks;
receiving, from a data source device, a request for a data path including one or more data processing tasks to be performed by devices in the one or more networks on behalf of the data source device;
in response to receiving the request from the data source device, processing, using a routing process, the request to generate a data path including connection and device information from the one or more networks,
wherein the connection and device information are obtained from querying the database, and
wherein the data path is configured for the one or more data processing tasks to be performed by devices in the one or more networks on behalf of the data source device; and
transmitting the data path to the data source device for routing network packets to a data destination device,
wherein the data source device, in response to receiving the data path, determines whether the data path satisfies the one or more data processing tasks included in the request,
wherein the data source device, in response to determining that the data path satisfies the one or more data processing tasks, selects the data path for routing the network packets to the data destination device,
wherein the one or more data processing tasks to be performed by devices in the one or more networks on behalf of the data source device include removing metadata from network packets to be transmitted, shuffling the network packets, or re-encrypting the network packets, and
wherein the devices in the one or more networks are determined to meet requirements as to a country, a network, a physical boundary, or a logical boundary within which or outside of which the network packets, communication, code, or computation is performed or conveyed.

2. A non-transitory computer-readable medium storing instructions that, when executed by one or more processors, cause operations comprising:
generating a database including information related to connections existing in one or more networks and devices included in the one or more networks;
receiving, from a data source device, a request for a data path including one or more data processing tasks to be performed by devices in the one or more networks on behalf of the data source device;
in response to receiving the request from the data source device, processing the request to generate a data path including connection and device information from the one or more networks,
wherein the connection and device information are obtained from querying the database, and
wherein the data path is configured for the one or more data processing tasks to be performed by devices in the one or more networks on behalf of the data source device; and
transmitting the data path to the data source device for routing network packets to a data destination device.

3. The non-transitory computer-readable medium of claim 2, wherein the data source device, in response to receiving the data path, determines whether the data path satisfies the one or more data processing tasks included in the request and, in response to determining that the data path satisfies the one or more data processing tasks, selects the data path for routing the network packets to the data destination device.

4. The non-transitory computer-readable medium of claim 2, wherein the data source device processes the network packets prior to routing the network packets to the data destination device, including placing the network packets into a secure channel secured by encryption, packet obfuscation, packet normalization, and/or traffic padding.

5. The non-transitory computer-readable medium of claim 2, wherein the one or more data processing tasks to be performed by devices in the one or more networks on behalf of the data source device include removing metadata from traffic, shuffling and/or mixing the traffic, and/or re-encrypting the traffic, wherein the devices in the one or more networks determine a destination for a network packet based on information included in the network packet or information provided out of band via a control plane communication.

6. The non-transitory computer-readable medium of claim 2, wherein the devices in the one or more networks are determined to meet requirements as to a country, a network, a physical boundary, and/or a logical boundary within which or outside of which the network packets, communication, code, or computation is performed or conveyed, wherein the devices in the one or more networks are determined to meet requirements using information from the database to determine whether the one or more networks and/or the devices in the one or more networks and/or paths between the one or more networks involve transmission of network packets through a physical or logical boundary not desired by one or more parties to the communication.

7. The non-transitory computer-readable medium of claim 2, wherein the data source device, the data destination device, and/or one or more of the devices generates a request for blocking transmission of a network packet by the one or more networks, wherein the network packet is stamped with a privacy-preserving stamp that enables blocking transmission of the network packet by the one or more networks.

8. The non-transitory computer-readable medium of claim 2, wherein determining that the data path satisfies the one or more data processing tasks includes sending test traffic along the data path to verify that criteria for the one or more data processing tasks are met during live use of the data path.

9. The non-transitory computer-readable medium of claim 2, wherein the data destination device performs one or more abuse prevention operations to assess whether received data is undesirable and to notify the devices in the one or more networks and/or the data source device that at least some of the received data is unwanted or considered to be an attack or an abuse of the one or more networks.

10. The non-transitory computer-readable medium of claim 9, wherein the data destination device performs the one or more abuse prevention operations by extracting an anonymous path identifier from the received data which contains a cryptographic signature and transmits the anonymous path identifier to a compliance service to request that a source for the anonymous path identifier be prevented from sending further data via the data path.

11. The non-transitory computer-readable medium of claim 9, wherein the data destination device collects statistics about a quality of data transmission by monitoring bandwidth, delay, loss, jitter and/or network characteristics and/or other expected data processing tasks from the one or more networks on the data path.

12. A method for providing secure network routing as a service, comprising:
retrieving database information including information related to connections existing in one or more networks and devices included in the one or more networks;
receiving, from a source user computer, a request for a data path including one or more data processing tasks to be performed by devices in the one or more networks on behalf of the source user computer;
in response to receiving the request from the source user computer, processing the request to generate a proposed data path including connection and device information from the one or more networks,
wherein the connection and device information are obtained from querying the database information, and
wherein the data path is configured for the one or more data processing tasks to be performed by devices in the one or more networks on behalf of the source user computer; and
transmitting information related to the proposed data path to the source user computer for routing network packets to a data destination device if acceptance is received from the source user computer for the proposed data path.

13. The method of claim 12, wherein the source user computer processes the network packets prior to routing the network packets to the data destination device, including placing the network packets into a secure channel secured by encryption, packet obfuscation, packet normalization, and/or traffic padding.

14. The method of claim 12, wherein the one or more data processing tasks to be performed by devices in the one or more networks on behalf of the source user computer include removing metadata from traffic, shuffling and/or mixing the traffic, and/or re-encrypting the traffic, wherein the devices in the one or more networks determine a destination for a network packet based on information included in the network packet or information provided out of band via a control plane communication.

15. The method of claim 12, wherein the devices in the one or more networks are determined to meet requirements as to a country, a network, a physical boundary, and/or a logical boundary within which or outside of which the network packets, communication, code, or computation is performed or conveyed, wherein the devices in the one or more networks are determined to meet requirements using information from the database information to determine whether the one or more networks and/or the devices in the one or more networks and/or paths between the one or more networks involve transmission of network packets through a physical or logical boundary not desired by one or more parties to the communication.

16. The method of claim 12, wherein the source user computer, the data destination device, and/or one or more of the devices generates a request for blocking transmission of a network packet by the one or more networks, wherein the network packet is stamped with a privacy-preserving stamp that enables blocking transmission of the network packet by the one or more networks.

17. The method of claim 12, wherein determining that the data path satisfies the one or more data processing tasks includes sending test traffic along the data path to verify that criteria for the one or more data processing tasks are met during live use of the data path.

18. The method of claim 12, wherein the data destination device performs one or more abuse prevention operations to assess whether received data is undesirable and to notify the devices in the one or more networks and/or the source user computer that at least some of the received data is unwanted or considered to be an attack or an abuse of the one or more networks.

19. The method of claim 18, wherein the data destination device performs the one or more abuse prevention operations by extracting an anonymous path identifier from the received data which contains a cryptographic signature and transmits the anonymous path identifier to a compliance service to request that a source for the anonymous path identifier be prevented from sending further data via the data path.

20. The method of claim 18, wherein the data destination device collects statistics about a quality of data transmission by monitoring bandwidth, delay, loss, jitter and/or network characteristics and/or other expected data processing tasks from the one or more networks on the data path.
